(19) United States
(12) Patent Application Publication
(10) Pub. No.: US 2026/0064528 A1
(43) Pub. Date: Mar. 5, 2026

(54) DETECTING DIE FAILURE IN MEMORY SUB-SYSTEMS

(71) Applicant: Micron Technology, Inc., Boise, ID (US)

(72) Inventors: Su Juan Wang, Shanghai (CN); Guang Shen, Shanghai (CN)

(21) Appl. No.: 18/823,116

(22) Filed: Sep. 3, 2024

(51) Int. Cl. G06F 11/10; G06F 11/07

(52) U.S. Cl. CPC G06F 11/1068; G06F 11/076; G06F 11/1016

(57) ABSTRACT

A plurality of commands comprising data to be written to a plurality of blockstripes, each blockstripe comprising at least one block from each of a plurality of memory devices, can be received from a high-speed processing device. Based on determining a first memory device associated with a first blockstripe experiences program failure in response to execution of a first command, whether a second memory device associated with a second blockstripe experiences program failure in response to execution of a second command, can be determined. Based on detecting consecutive program failure on the memory device, whether a program failure count associated with the memory device satisfies a program failure threshold can be determined. Based on determining the program failure count associated with the memory device satisfies the program failure threshold, retirement of the memory device can be initiated.

### TECHNICAL FIELD

Embodiments of the disclosure relate generally to memory sub-systems, and more specifically, relate to detecting die failure in memory sub-systems.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system, in accordance with some embodiments of the present disclosure.

FIG. 2 illustrates an example computing system that includes a memory sub-system, in accordance with some embodiments of the present disclosure.

FIG. 3 illustrates a flow diagram of an example method of detecting die failure in memory sub-systems, in accordance with some embodiments of the present disclosure.

FIG. 4 illustrates an example memory device, in accordance with some embodiments of the present disclosure.

FIG. 5 illustrates an example method for detecting die failure in memory sub-systems, in accordance with some embodiments of the present disclosure.

FIG. 6 illustrates a block diagram of an example computer system in which embodiments of the present disclosure may operate.

### DETAILED DESCRIPTION

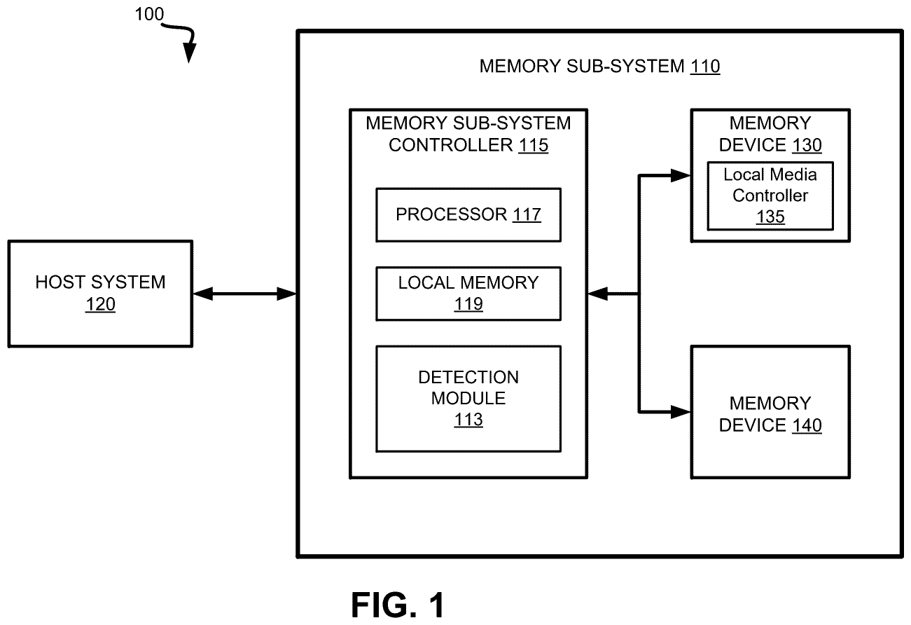

Aspects of the present disclosure are directed to detecting die failure in memory sub-systems. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include a plurality of high-speed central processing units (HS CPUs) that communicate (e.g., via a system bus) with at least a plurality of channel CPUs. A channel CPU can be coupled to a plurality of memory devices (e.g., non-volatile memory devices) on a channel that corresponds to the channel CPU. One example of non-volatile memory devices is a not-and (NAND) memory device. A non-volatile memory device is a package of one or more dies. Each die can include one or more planes. For some types of non-volatile memory devices (e.g., NAND devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0”and “1”, or combinations of such values.

A HS CPU can transmit commands (e.g., read commands, write commands) to a channel CPU for execution on one or more dies associated with a specific memory device (e.g., a NAND memory device) on the channel. In some instances, a CPU channel controller associated with the channel can schedule and/or execute the received commands on one or more dies of the memory device. In some instances, a plurality of dies associated with the memory device can be associated with a plurality of channels such that each channel includes a subset of the plurality of dies associated with the memory device. For example, a memory device (e.g., an 8T SSD) can contain 64 dies that can be distributed across 16 channels such that each channel includes 4 dies.

As described above, each die can contain a plurality of planes (e.g., planes P0 to Px) and each plane can include multiple memory cells (also referred to herein as blocks). A blockstripe can include a subset of blocks associated with each plane of each die on a memory device. Data can be written to the memory device by programming consecutive blockstripes. However, in some instances, program failure can occur when programming one or more blocks within a blockstripe. In conventional memory sub-systems, when program failure is detected on the blockstripe being programmed, a HS CPU associated with the memory device that experiences program failure (e.g., the HS CPU that transmitted a write command to the channel CPU associated with the memory device) can terminate programming of the blockstripe. The data written to the blockstripe that experiences program failure (e.g., blockstripe BS0) can be written to the next blockstripe (e.g., blockstripe BS1). One or more blocks on the blockstripe that experienced program failure can be flagged as bad blocks, and a bad block count can be incremented.

This method of detecting and handling program failure can be difficult to implement as the capacity of the memory device increases. As the capacity of the memory device increases, the number of dies associated with the memory device can increase and the size of the blocks associated with the dies can increase. The failure to accurately track each block associated with a die can cause sudden die failure. When the die fails, the conventional method of handling program failure may be ineffective. For example, when a blockstripe comprising blocks of a failed die experiences program failure, the HS CPU can initiate programming of the next blockstripe, but the next blockstripe, which also comprises blocks of the failed die, can also experience program failure. As such, programming the blockstripes that comprise blocks of the failed die can lead to a dead loop and can ultimately cause drive hang. To avoid triggering program failure each time a blockstripe comprising blocks of the failed die is programmed, the HS CPU can temporarily flag specific blocks of the failed die as bad blocks so that the data to be written to the current blockstripe can be written to the next blockstripe. The HS CPU can retire the failed die and/or the memory device when the number of temporarily flagged bad blocks is equal to a threshold number of bad blocks. However, depending on an amount of time needed for the bad block count to match the threshold number of bad blocks, this method of handling program failure might not enable the HS CPU to perform timely die failure detection and can overkill a good die.

Aspects of the present disclosure address the above and other deficiencies by using instances of consecutive program failure to detect die failure. The die failure detection method described herein can be performed by any channel CPU, of the plurality of channel CPUs, that is associated with a memory device. As described above, the dies associated with the memory device can be associated with different channels such that each channel can correspond to a subset of dies associated with the memory device. Each channel can correspond to a channel identifier (e.g., a numerical identifier) and be associated with a channel CPU that monitors the dies on the channel. Each die on the channel can correspond to a die identifier (e.g., a numerical identifier), which the corresponding channel CPU can use to identify dies that experience program failure.

A channel CPU can receive, from a HS CPU (e.g., a write handler HS CPU), a write command containing data to be written to a blockstripe of the memory device. The channel CPU can write the data to one or more blocks across one or more dies of a blockstripe that is currently being programmed. The channel CPU can observe the one or more blocks to determine whether a block experiences program failure. Based on determining a block experiences program failure during the programming of a current blockstripe, the channel CPU can identify the die associated with the block (e.g., based on a corresponding die identifier). The channel CPU can terminate programming of the current blockstripe and determine whether the die experiences consecutive program failure (e.g., during programming of the next blockstripe). Based on determining the die experiences consecutive program failure, the channel CPU can increment a program failure count for the die on which the block is located. Additionally or alternatively, the channel CPU can reset the program failure count (e.g., set to 0) based on determining the die does not experience consecutive program failure (e.g., based on determining the block is successfully programmed).

For example, a block on plane P0 of die D0 in blockstripe BS0 can experience program failure during the execution of a first write command. If die D0 in blockstripe BS1 experiences program failure (e.g., the same block on plane P0) during the execution of a second write command (e.g., consecutive instances of program failure), then the channel CPU associated with die D0 can increment the program failure count of die D0. Based on incrementing the program failure count of die D0, the channel CPU associated with die D0 can determine whether the program failure count satisfies (e.g., is equal to or greater than) a threshold number of program failures. When the program failure count satisfies the threshold, the channel CPU associated with die D0 can initiate a die retirement process. In some instances, the channel CPU associated with die D0 can initiate a process of rebuilding die D0, which experiences die failure. However, if die D0 in blockstripe BS1 is successfully programmed as a result of the second write command, then the channel CPU associated with die D0 can reset the program failure count of die D0 (e.g., set the program failure count to 0).

Advantages of the present disclosure include, but are not limited to, performing die failure detection by one or more channel CPUs to provide timely die failure detection and timely initiation of the die retirement and/or rebuild process. Advantages also include the timely termination of read and/or write commands that are transmitted from a HS CPU to a channel CPU. The termination of read/write commands on the die experiencing program failure can avoid the overkill of a good die.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a detection module 113 that can perform the die failure detection method described herein. In some embodiments, the memory sub-system controller 115 includes at least a portion of the detection module 113. In some embodiments, the detection module 113 is part of the host system 120, an application, or an operating system. In other embodiments, local media controller 135 includes at least a portion of the detection module 113 and is configured to perform the functionality described herein.

The detection module 113 can determine, for each die associated with a memory device, whether a die experiences consecutive program failure as a result of programming consecutive blockstripes. Based on detecting consecutive program failure, the detection module 113 can increment a program failure count associated with the die and determine, based on the program failure count, whether to retire the die. However, based on determining consecutive blockstripes are programmed successfully, the detection module 113 can reset the program failure count to, for example, 0. Further details regarding the operations of the detection module 113 are described below.

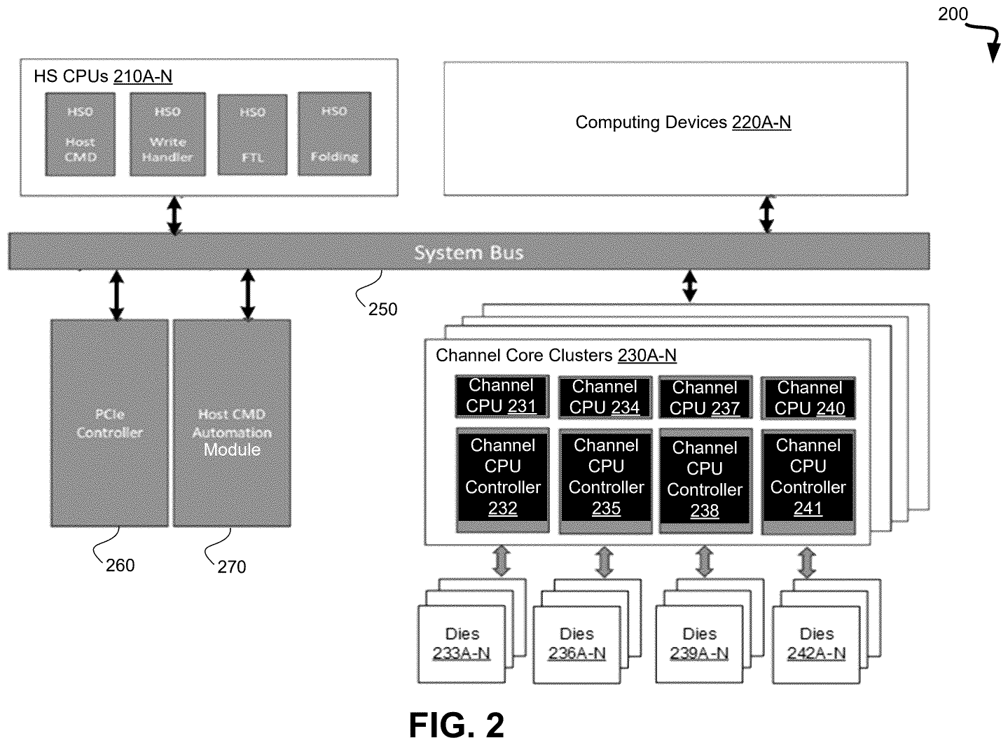

FIG. 2 illustrates an example computing system that includes a memory sub-system, in accordance with some embodiments of the present disclosure. Example computing system 200 can include high-speed central processing units (CPUs) 210a-n, computing devices 220a-n, system bus 250, PCIe controller 260, host command prompt (CMD) automation module 270, and/or channel core clusters 230a-n.

A HS CPU can be a CMD host CPU, a write handler CPU, a flash translation layer (FTL) CPU, and/or a folding CPU. In some instances, any one of HS CPUs 210a-n can be configured to perform the operations of the HS CPUs described herein.

Computing system 200 can further include additional computing devices, such as computing devices 220a-n. Computing devices 220a-n can correspond to any of a double data rate (DDR) controller, a universal asynchronous receiver/transmitter (UART), a power management unit (PMU), a component that implements an improved inter integrated circuit (I3C) standard, a distributed management environment (DME) component, and/or additional and/or alternative memory devices (e.g., a static random-access memory (SRAM) device).

In some instances, computing system 200 can include a peripheral component interconnect express (PCIe) controller 260. The PCIe controller 260 can facilitate communication between the computing system 200 and one or more peripheral devices couples to the computing system 200. The computing system 200 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

In some instances, computing system 200 can include the host CMD automation module 270. The host CMD automation module 270 can, for example, generate and/or define one or more commands (e.g., read commands, write commands, or the like).

Computing system 200 can include channel core clusters 230a-n. A channel core cluster can include a plurality of channels associated with a memory device (e.g., a NAND memory device). As described above, each channel can include a channel CPU (e.g., channel CPUs 231, 234, 237, 240) and a channel CPU controller (e.g., channel CPU controllers 232, 235, 238, 241). As described above, each channel can include a plurality of dies associated with the memory device (e.g., dies 233a-n, 236a-n, 239a-n, 242a-n), and each die can include a plurality of blocks. The plurality of blocks can be associated with a plurality of blockstripes of the memory device where a blockstripe includes at least one block of each die associated with the memory device. The blockstripes can be consecutively programmed in order to program the memory device.

A channel can receive (e.g., via a channel CPU and/or a channel CPU controller associated with the channel), from a HS CPU (e.g., one of HS CPUs 210a-n), a series of commands to be executed on the memory device associated with the channel. For example, the channel CPU and/or the channel CPU controller can receive a series of commands to program the memory device (e.g., write specific data to the memory device). In some instances, the channel CPU controller associated with the channel can coordinate the execution of the series of commands. In some instances, the channel CPU can program the memory device by writing data to consecutive blockstripes of the memory device. The channel CPU can determine whether one or more blocks of consecutive blockstripes experience consecutive instances of program failure. The channel CPU can maintain a program failure count for each die. The channel CPU can identify (e.g., using a die identifier) the die experiencing consecutive instances of program failure. In some instances, the channel CPU can increment the program failure count associated with a die based on detecting consecutive instances of program failure of one or blocks on the die. Additionally or alternatively, the channel CPU can reset the program failure count based on determining each block on a blockstripe is programmed successfully. The channel CPU can determine whether to retire and/or rebuild the die based on the program failure count associated with the die.

In some instances, the components of computing system 200 (e.g., HS CPUs 210a-n, computing devices 220a-n, channel core clusters 230a-n, dies 233a-n, dies 236a-n, dies 239a-n, dies 242a-n, PCIe controller 260, and/or host CMD automation module 270) can communicate via system bus 250.

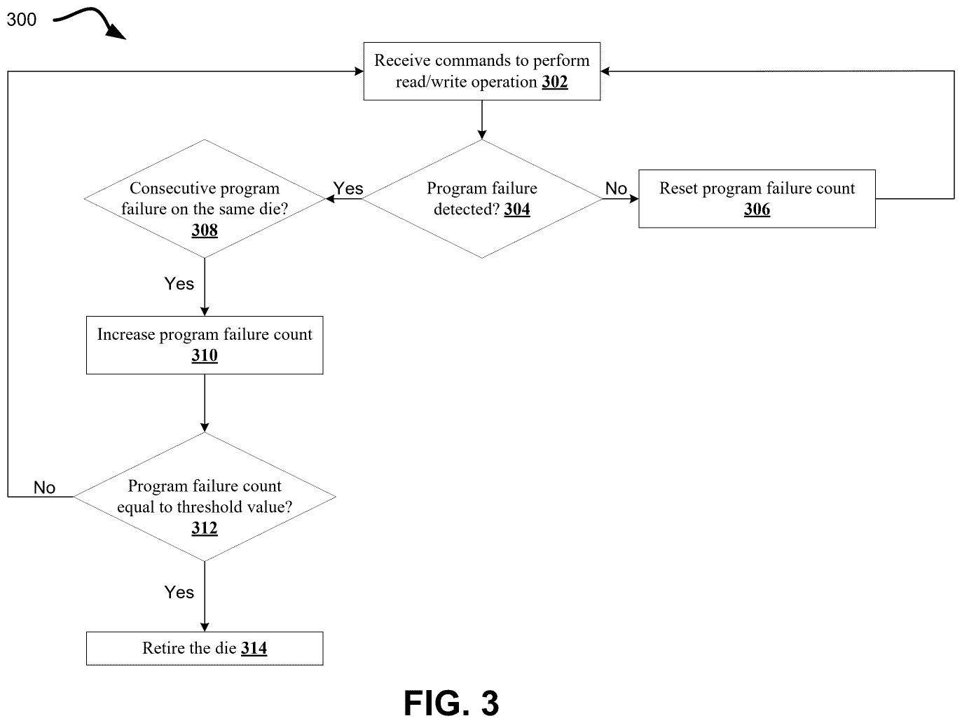

FIG. 3 illustrates a flow diagram of an example method of detecting die failure in memory sub-systems, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the detection module 113 of FIG. 1 and/or any of channel CPUs 231, 234, 237, or 240 of FIG. 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 302, the processing logic (e.g., the detection module 113 and/or any of channel CPUs 231, 234, 237, 240) can receive a plurality of commands to program a memory device. The plurality of commands can include specific data to be written to the memory device. For example, a channel CPU can receive the plurality of commands from a HS CPU (e.g., any of HS CPUs 210a-n) and execute the plurality of commands (e.g., sequentially) by programming consecutive blockstripes of the memory device.

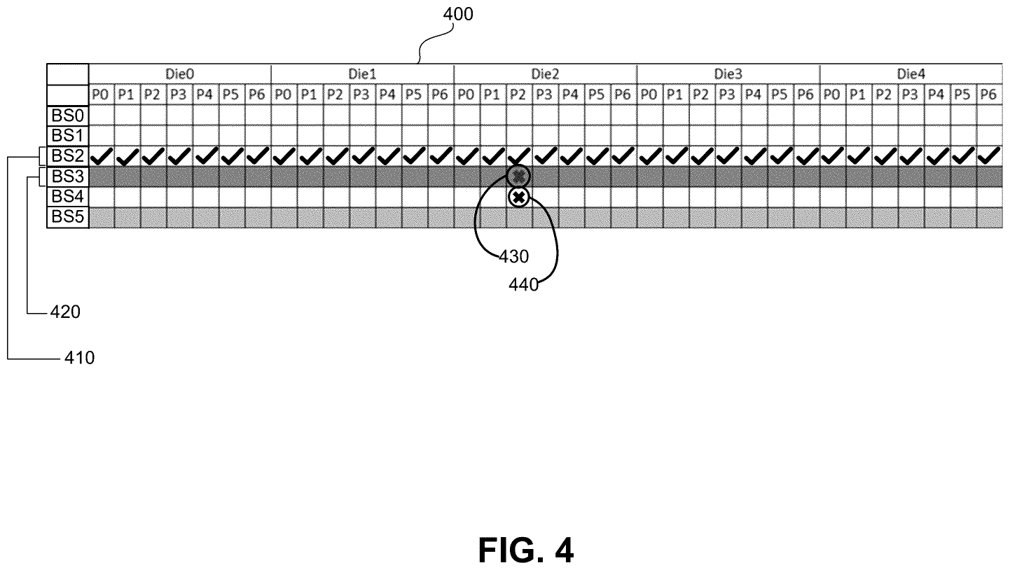

At operation 304, the processing logic (e.g., the channel CPU) can determine whether one or more blocks of the current blockstripe being programmed experience program failure as a result of writing data to the memory device during execution of a first command. FIG. 4 illustrates an example memory device 400, in accordance with some embodiments of the present disclosure. Referring to FIG. 4, the processing logic (e.g., the channel CPU) can determine whether any blocks of blockstripe BS2 experience program failure. As illustrated by element 410, each block (e.g., on each of planes P0 to P6 of die0 to die4) on blockstripe BS2 is successfully programmed.

If, at operation 304, the processing logic (e.g., the channel CPU) determines that each block of the current blockstripe being programmed is successfully programmed, then, at operation 306, the processing logic can reset a program failure count. For example, the channel CPU can reset a program failure count associated with each die (e.g., die0 to die4) of the memory device based on determining that each block associated with the current blockstripe being programmed is successfully programmed.

In some instances, at operation 304, the processing logic (e.g., the channel CPU) can determine that at least one block of the current blockstripe being programmed experiences program failure. Referring to FIG. 4, element 420 indicates that the current blockstripe being programmed is blockstripe BS3. As illustrated by element 430, the processing logic (e.g., the channel CPU) can determine that a block within plane P2 of die2 experiences program failure during the programming of blockstripe BS3.

If, at operation 304, the processing logic (e.g., the channel CPU) detects program failure on at least one block associated with a die of the current blockstripe being programmed, then, at operation 308, the processing logic (e.g., the channel CPU) can determine whether the die experiences consecutive program failure. In particular, the processing logic (e.g., the channel CPU) can determine whether the die also experiences program failure during the programming of the next blockstripe. The processing logic (e.g., the channel CPU) can identify the die that corresponds to the block that experiences program failure based on, for example, a die identifier (e.g., a unique numerical identifier) associated with the die. For example, referring to FIG. 4, based on determining that a block within plane P2 of die2 experiences program failure during the programming of blockstripe BS3, the processing logic (e.g., the channel CPU) can determine whether die2 experiences program failure (e.g., on the same block within plane P2) during the programming of the next blockstripe (e.g., BS4).

If, at operation 308, the processing logic (e.g., the channel CPU) determines that the die experiences consecutive program failure during programming of the next blockstripe, then, at operation 310, the processing logic (e.g., the channel CPU) can increment a program failure count associated with the die. For example, as illustrated by element 440 of FIG. 4, the processing logic (e.g., the channel CPU) can determine that die2 experiences program failure during the programming of one or more blocks on plane P2 during the programming of blockstripe BS4. The processing logic (e.g., the channel CPU) can increment a program failure count associated with the die.

At operation 312, the processing logic (e.g., the channel CPU) can determine whether the program failure count associated with the die satisfies (e.g., is equal to or greater than) a program failure threshold. Based on determining, at operation 312, that the program failure count associated with the die does not satisfy the program failure threshold, then the processing logic (e.g., the channel CPU) can return to operation 302.

However, based on determining, at operation 312, that the program failure count associated with the die satisfies the program failure threshold, then, at operation 314, the processing logic (e.g., the channel CPU) can retire the die. In some instances, the processing logic (e.g., the channel CPU) can initiate a process of rebuilding the failed die.

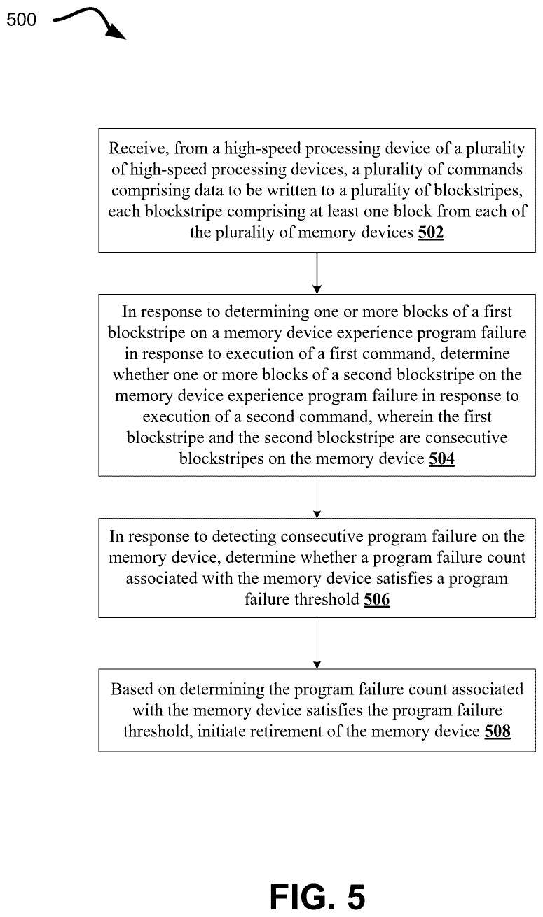

FIG. 5 illustrates an example method for detecting die failure in memory sub-systems, in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the detection module 113 of FIG. 1 and/or any of channel CPUs 231, 234, 237, and/or 240 of FIG. 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 502, the processing logic can receive, from a high-speed processing device (e.g., any of HS CPUs 210a-n) of a plurality of high-speed processing devices, a plurality of commands comprising data to be written to a plurality of blockstripes. Each blockstripe can include at least one block from each of a plurality of memory devices. For example, each blockstripe can include at least one block from each die.

At operation 504, based on determining one or more blocks of a first blockstripe on a memory device experience program failure in response to execution of a first command, the processing logic can determine whether one or more blocks of a second blockstripe on the memory device experience program failure in response to execution of a second command. The first blockstripe and the second blockstripe can be consecutive blockstripes on the memory device. In some instances, the processing logic can determine whether a first memory device associated with the first blockstripe that experiences program failure and a second memory device associated with the second blockstripe that experiences program failure are the same memory device. If the first memory device associated with the first blockstripe that experiences program failure and the second memory device associated with the second blockstripe that experiences program failure are the same memory device, then the processing logic can determine that the memory device experiences consecutive program failure (e.g., during programming of the first blockstripe and the second blockstripe).

At operation 506, based on detecting consecutive program failure on the memory device, the processing logic can determine whether a program failure count associated with the memory device satisfies a program failure threshold. Based on detecting consecutive program failure on the memory device, the processing logic can increment the program failure count associated with the memory device (e.g. a die). The processing logic can compare the program failure count associated with the memory device (e.g. the die) to the program failure threshold. The processing logic can determine that the program failure count satisfies the program failure threshold when the program failure count is equal to or greater than the program failure threshold. Additionally or alternatively, the program failure count does not satisfy the program failure threshold when the program failure count is less than the program failure threshold.

At operation 508, based on determining the program failure count associated with the memory device (e.g., the die) satisfies the program failure threshold, the processing logic can initiate retirement of the memory device (e.g., the die).

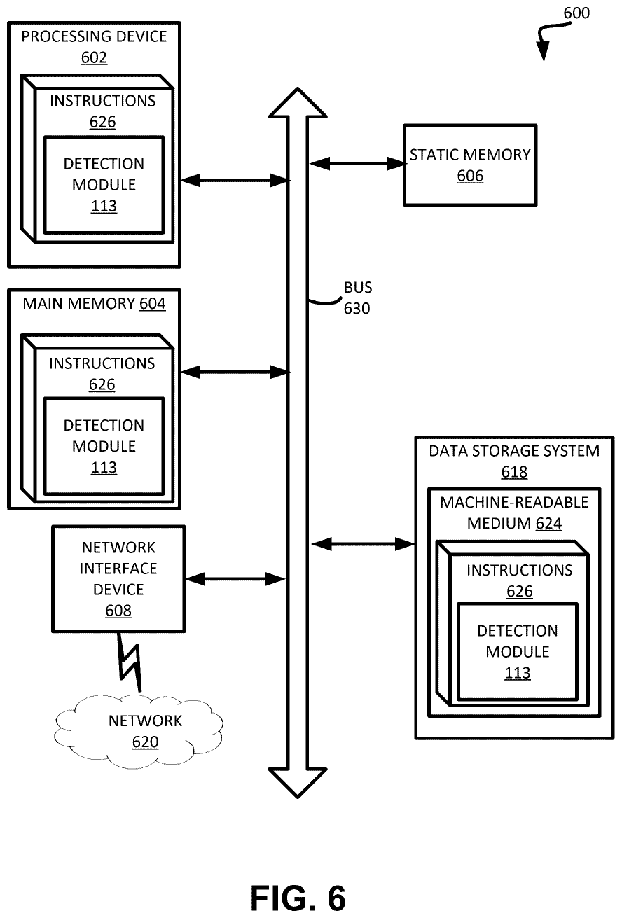

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the scan module 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or RDRAM, etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality corresponding to a detection module (e.g., the detection module 113 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a plurality of memory devices;
a plurality of high-speed processing devices; and
a plurality of channel cores operatively coupled to the plurality of memory devices and configured to perform operations comprising:
receiving, from a high-speed processing device of the plurality of high-speed processing devices, a plurality of commands comprising data to be written to a plurality of blockstripes, each blockstripe comprising at least one block from each of the plurality of memory devices;
in response to determining that one or more blocks of a first blockstripe on a memory device of the plurality of memory devices experience program failure in response to execution of a first command of the plurality of commands, determining whether one or more blocks of a second blockstripe on the memory device experience program failure in response to execution of a second command, wherein the first blockstripe and the second blockstripe are consecutive blockstripes on the memory device;
in response to detecting consecutive program failure on the memory device, determining whether a program failure count associated with the memory device satisfies a program failure threshold; and
in response to determining that the program failure count associated with the memory device satisfies the program failure threshold, initiating retirement of the memory device.

2. The system of claim 1, wherein the plurality of channel cores is further configured to perform operations comprising:
incrementing the program failure count associated with the memory device based on determining that a block of a blockstripe on the memory device experiences program failure.

3. The system of claim 1, wherein the plurality of channel cores is further configured to perform operations comprising:
determining whether a first memory device associated with the first blockstripe that experiences program failure and a second memory device associated with the second blockstripe that experiences program failure are the same memory device.

4. The system of claim 3, wherein the plurality of channel cores is further configured to perform operations comprising:
based on determining that the first memory device associated with the first blockstripe that experiences program failure and the second memory device associated with the second blockstripe that experiences program failure are the same memory device, determining that the memory device experiences consecutive program failure during programming of the first blockstripe and the second blockstripe.

5. The system of claim 1, wherein the plurality of channel cores is further configured to perform operations comprising:
based on determining that the second blockstripe is programmed without program failure, resetting the program failure count associated with the memory device.

6. The system of claim 1, wherein the plurality of channel cores is further configured to perform operations comprising:
determining that the program failure count associated with the memory device satisfies the program failure threshold when the program failure count associated with the memory device is greater than or equal to the program failure threshold.

7. The system of claim 1, wherein a channel comprises one or more memory devices of the plurality of memory devices, and wherein the channel is associated with a channel core of the plurality of channel cores.

8. A method comprising:
receiving, from a high-speed processing device of a plurality of high-speed processing devices coupled to a plurality of memory devices, a plurality of commands comprising data to be written to a plurality of blockstripes, each blockstripe comprising at least one block from each of the plurality of memory devices;
in response to determining that one or more blocks of a first blockstripe on a memory device of the plurality of memory devices experience program failure in response to execution of a first command of the plurality of commands, determining whether one or more blocks of a second blockstripe on the memory device experience program failure in response to execution of a second command, wherein the first blockstripe and the second blockstripe are consecutive blockstripes on the memory device;
in response to detecting consecutive program failure on the memory device, determining whether a program failure count associated with the memory device satisfies a program failure threshold; and
in response to determining that the program failure count associated with the memory device satisfies the program failure threshold, initiating retirement of the memory device.

9. The method of claim 8, further comprising incrementing the program failure count associated with the memory device based on determining that a block of a blockstripe on the memory device experiences program failure.

10. The method of claim 8, further comprising determining whether a first memory device associated with the first blockstripe that experiences program failure and a second memory device associated with the second blockstripe that experiences program failure are the same memory device.

11. The method of claim 10, further comprising, based on determining that the first memory device associated with the first blockstripe that experiences program failure and the second memory device associated with the second blockstripe that experiences program failure are the same memory device, determining that the memory device experiences consecutive program failure during programming of the first blockstripe and the second blockstripe.

12. The method of claim 8, further comprising, based on determining that the second blockstripe is programmed without program failure, resetting the program failure count associated with the memory device.

13. The method of claim 8, further comprising determining that the program failure count associated with the memory device satisfies the program failure threshold when the program failure count associated with the memory device is greater than or equal to the program failure threshold.

14. A non-transitory computer readable storage medium comprising instructions that, when executed by a plurality of channel cores, cause the plurality of channel cores to perform operations comprising:
receiving, from a high-speed processing device of a plurality of high-speed processing devices coupled to a plurality of memory devices, a plurality of commands comprising data to be written to a plurality of blockstripes, each blockstripe comprising at least one block from each of the plurality of memory devices;
in response to determining that one or more blocks of a first blockstripe on a memory device of the plurality of memory devices experience program failure in response to execution of a first command of the plurality of commands, determining whether one or more blocks of a second blockstripe on the memory device experience program failure in response to execution of a second command, wherein the first blockstripe and the second blockstripe are consecutive blockstripes on the memory device;
in response to detecting consecutive program failure on the memory device, determining whether a program failure count associated with the memory device satisfies a program failure threshold; and
in response to determining that the program failure count associated with the memory device satisfies the program failure threshold, initiating retirement of the memory device.

15. The non-transitory computer readable storage medium of claim 14, wherein the plurality of channel cores is further configured to perform operations comprising:
incrementing the program failure count associated with the memory device based on determining that a block of a blockstripe on the memory device experiences program failure.

16. The non-transitory computer readable storage medium of claim 14, wherein the plurality of channel cores is further configured to perform operations comprising:
determining whether a first memory device associated with the first blockstripe that experiences program failure and a second memory device associated with the second blockstripe that experiences program failure are the same memory device.

17. The non-transitory computer readable storage medium of claim 16, wherein the plurality of channel cores is further configured to perform operations comprising:
based on determining that the first memory device associated with the first blockstripe that experiences program failure and the second memory device associated with the second blockstripe that experiences program failure are the same memory device, determining that the memory device experiences consecutive program failure during programming of the first blockstripe and the second blockstripe.

18. The non-transitory computer readable storage medium of claim 14, wherein the plurality of channel cores is further configured to perform operations comprising:
based on determining that the second blockstripe is programmed without program failure, resetting the program failure count associated with the memory device.

19. The non-transitory computer readable storage medium of claim 14, wherein the plurality of channel cores is further configured to perform operations comprising:
determining that the program failure count associated with the memory device satisfies the program failure threshold when the program failure count associated with the memory device is greater than or equal to the program failure threshold.

20. The non-transitory computer readable storage medium of claim 14, wherein a channel comprises one or more memory devices of the plurality of memory devices, and wherein the channel is associated with a channel core of the plurality of channel cores.
